(19) United States
(12) Patent Application Publication
(10) Pub. No.: US 2026/0289499 A1
(43) Pub. Date: Sep. 24, 2026

(54) System and Method Suitable for Coordinating and Controlling the Movement of Trailers by a Fleet of Vehicles within a Logistics Environment

(71) Applicant: Mitsubishi Electric Research Laboratories, Inc., Cambridge, MA (US)

(72) Inventors: Stefano Di Cairano, Newton, MA (US); Gustavo Cardona, Bethlehem, PA (US)

(73) Assignee: Mitsubishi Electric Research Laboratories, Inc., Cambridge, MA (US)

(21) Appl. No.: 19/279,153

(22) Filed: Jul. 24, 2025

Related U.S. Application Data
(60) Provisional application No. 63/774,237, filed on Mar. 19, 2025.

(51) Int. Cl. G06Q 10/087; G06Q 10/047; G06Q 10/0631; G08G 1/0967; G08G 1/0968

(52) U.S. Cl. CPC G06Q 10/08743; G06Q 10/047; G06Q 10/06312; G08G 1/096725; G08G 1/096888

(57) ABSTRACT

The present disclosure provides a system and a method for coordinating and controlling the movement of trailers by a fleet of vehicles within a logistics environment. The method comprises receiving a set of trailer transportation jobs, each job comprising a temporal requirement defining conditions to be satisfied by a trailer or a vehicle at a location during a time interval, and encoding the temporal requirement of each job as a set of constraints on one or more of vehicle motion dynamics, trailer motion dynamics, and energy consumption behavior using metric temporal logic (MTL) specification. The method further solving a constrained optimization problem optimizing a cost function subject to the set of constraints and a set of vehicle operation constraints to generate a plan comprising one or more trailer assignments, vehicle trajectories, and charging actions, and executing at least a portion of the plan within the logistics environment.

### TECHNICAL FIELD

The present disclosure relates generally to automated task planning and control in logistics environments, and more specifically to a system and a method suitable for coordinating and controlling the movement of trailers by a fleet of vehicles within a logistics environment.

### BACKGROUND

Modern logistics environments, such as warehouse yards and distribution terminals, serve as critical hubs for transferring of goods between transportation modes. In such logistics environments, the movement of trailers between staging areas, holding stations, and cocking stations, which can be loading for unloading, is frequently performed by a fleet of a vehicles, which may be autonomous or human-operated. These vehicles, often referred to as yard tractors or yard dogs, are tasked with performing transportation operations subject to operational constraints, safety considerations, and time-sensitive requirements.

The coordination of trailer movements in such settings involves complex decision-making under uncertainty. Specifically, assignment of trailer-handling tasks to the fleet of vehicles must account for locations of the trailers and the fleet of vehicles, timing requirements of tasks, vehicle energy availability (particularly for electric vehicles), and constraints on infrastructure usage such as road capacity or docking station availability. In many cases, the timing requirements of tasks include deadlines, minimum dwell times at certain locations, and mutual exclusions with other operations.

Existing solutions often treat task assignment and routing separately or rely on static planning methods that assume complete information and full mission feasibility. However, such assumptions do not hold in practice. The logistics environments are dynamic-tasks may arrive at arbitrary times, execution may deviate from planned behavior, and resource availability may change. Moreover, generating feasible plans that satisfy all task constraints, especially under timing and energy limitations, can lead to combinatorially complex planning problems.

Accordingly, there is a need for methods and systems that support scalable, adaptive planning for trailer coordination in the logistics environments.

### SUMMARY

Some embodiments of the present disclosure provide systems and methods for planning and coordinating the movement of trailers by a fleet of vehicles including electrically powered yard tractors, referred to herein as yard dogs (YDs), within structured logistics environments such as warehouse yards or shipping terminals. Further, the present disclosure provides a system that enables the generation of task plans that jointly consider trailer assignments, routing, timing constraints, and vehicle energy availability, with the goal of improving operational efficiency, responsiveness, and robustness.

Embodiments are based on recognizing that the problem of coordinating the movement of trailers is not merely one of assigning tasks, but involves multiple interdependent subproblems: task allocation, trajectory generation, and energy management. These subproblems influence each other—for example, the route taken by a YD affects the time and energy required to complete a task, which in turn influences feasibility of the task itself. This interdependence gives rise to what may be termed an internal coordination problem, wherein treating these subproblems in isolation can result in infeasible, inefficient, or suboptimal operations.

To address the internal coordination problem, some embodiments recognize that trailer missions and their constraints can be expressed using a formal specification language. In particular, Metric Temporal Logic (MTL) can be used to model the timing and sequencing of events, such as deadlines, durations at specified locations, and resource exclusions. This recognition enables consolidation of task requirements, operational constraints, and timing rules into a unified formal representation that can be systematically compiled into a planning problem.

Further embodiments recognize that while MTL provides a powerful specification framework, direct enforcement of the constraints over long planning horizons through Mixed Integer Linear Programming (MILP) can lead to excessive computational complexity. The size and structure of MILP problem scale with a number of vehicles, a number of tasks, and resolution of time discretization, a length of the time to complete the task, posing a practical barrier to real-time deployment in dynamic environments.

To address such a challenge related to the MILP problem, some embodiments reformulate the MILP problem into a receding planning horizon framework. In the receding planning horizon framework, the MILP problem is solved iteratively over short, finite horizons, enabling the system to adapt to dynamic task arrivals, vehicle state changes, and execution variability. At each planning step, the system uses a current state as an initial condition and generates a partial plan that may be updated in subsequent iterations. The receding planning horizon framework maintains tractability while enabling responsiveness to real-time changes.

Another recognition underlying some embodiments is that binary treatment of temporal constraint satisfaction may obscure the utility of partial task progress. In typical logic-based formulations, a constraint is either satisfied in full or not at all. However, in the receding planning horizon framework, actions that move a trailer closer to its goal or prepare a YD for a future assignment may still be highly valuable, particularly in constrained or overloaded scenarios. Hence, some embodiments define satisfaction metrics over MTL formulation and incorporate them into a cost function of the MILP problem. The system may then evaluate and select actions not only based on full satisfaction of mission goals, but also based on how much the actions advance the system toward the mission goals. As a result, the system operates productively even when full task completion is temporarily infeasible, thereby improving continuity of operations and reducing idle time.

Further recognition is given to the role of vehicle energy constraints in shaping task feasibility. Electrically powered YDs consume energy when moving and may periodically recharge at designated stations. The MILP problem therefore includes variables and constraints to track battery levels, schedule charging actions, and account for energy consumption along different routes. Thereby, ensuring that task planning remains consistent with actual capabilities of the fleet of vehicles.

Taken together, the aforesaid recognitions support a planning and controlling framework that is not only formally grounded and computationally efficient, but also operationally effective in real-world environments. By identifying and addressing internal causes of planning infeasibility-such as tight coupling of task structure, energy dynamics, and time-sensitive constraints, and or partial success incorporation-some embodiments enable the system to adapt to changing conditions, maximizes throughput, and utilizes resources efficiently. To this end, the system supports scalable, resilient, and high-fidelity trailer coordination in logistics facilities.

Accordingly, one embodiment discloses a system for coordinating and controlling the movement of trailers by a fleet of vehicles within a logistics environment. The system comprises a processor; and a memory having instructions stored thereon that, when executed by the processor, cause the controller to: receive a set of trailer transportation jobs, each job comprising a temporal requirement defining conditions to be satisfied by a trailer or a vehicle at a location during a time interval; encode the temporal requirement of each job as a set of constraints on one or more of vehicle motion dynamics, trailer motion dynamics, and energy consumption behavior using metric temporal logic (MTL) specification; solve a constrained optimization problem optimizing a cost function subject to the set of constraints and a set of vehicle operation constraints to generate a plan comprising one or more trailer assignments, vehicle trajectories, and charging actions, wherein the cost function includes a trailer motion cost and an energy consumption cost indicative of a total amount of energy of the fleet of trucks; and execute at least a portion of the plan within the logistics environment to control the movement of the trailers by the fleet of vehicles. The execution of the plan may be operated by an autonomous system on board of the fleet of vehicles, executing the plan, or by a human driver driving the vehicle to follow the plan.

Accordingly, another embodiment discloses a method for coordinating and controlling the movement of trailers by a fleet of vehicles within a logistics environment. The method comprises receiving a set of trailer transportation jobs, each job comprising a temporal requirement defining conditions to be satisfied by a trailer or a vehicle at a location during a time interval; encoding the temporal requirement of each job as a set of constraints on one or more of vehicle motion dynamics, trailer motion dynamics, and energy consumption behavior using metric temporal logic (MTL) specification; solving a constrained optimization problem optimizing a cost function subject to the set of constraints and a set of vehicle operation constraints to generate a plan comprising one or more trailer assignments, vehicle trajectories, and charging actions, wherein the cost function includes a trailer motion cost and an energy consumption cost indicative of a total amount of energy of the fleet of trucks; and executing at least a portion of the plan within the logistics environment to control the movement of the trailers by the fleet of vehicles.

Accordingly, yet another embodiment discloses a non-transitory computer-readable storage medium embodied thereon a program executable by a processor for performing a method for coordinating and controlling the movement of trailers by a fleet of vehicles within a logistics environment. The method comprises receiving a set of trailer transportation jobs, each job comprising a temporal requirement defining conditions to be satisfied by a trailer or a vehicle at a location during a time interval; encoding the temporal requirement of each job as a set of constraints on one or more of vehicle motion dynamics, trailer motion dynamics, and energy consumption behavior using metric temporal logic (MTL) specification; solving a constrained optimization problem optimizing a cost function subject to the set of constraints and a set of vehicle operation constraints to generate a plan comprising one or more trailer assignments, vehicle trajectories, and charging actions, wherein the cost function includes a trailer motion cost and an energy consumption cost indicative of a total amount of energy of the fleet of trucks; and executing at least a portion of the plan within the logistics environment to control the movement of the trailers by the fleet of vehicles.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1 illustrates a logistics environment, according to an embodiment of the present disclosure.

FIG. 2A illustrates a system for coordinating and controlling the movement of trailers by a fleet of vehicles in the logistics environment, according to some embodiments of the present disclosure.

FIG. 2B illustrates functions executed by the system to coordinate and control the movement of the trailers by the fleet of vehicles, according to some embodiments of the present disclosure.

FIG. 2C illustrates a constrained optimization problem, according to some embodiments of the present disclosure.

FIG. 2D illustrates an example plan and execution of the plan, according to some embodiments the present disclosure.

FIG. 3A illustrates the constrained optimization problem with a modified cost function, according to some embodiments of the present disclosure.

FIG. 3B illustrates a receding planning horizon framework, according to some embodiments of the present disclosure.

FIG. 3C illustrates solving the constrained optimization problem over a receding planning horizon, according to some embodiments of the present disclosure.

FIG. 4 illustrates a cost function including weighted costs, according to some embodiments of the present disclosure.

FIG. 5A illustrates a Mixed Integer Linear Programming (MILP) problem, according to some embodiments of the present disclosure.

FIG. 5B illustrates a set of linear constraints of the MILP problem, according to some embodiments of the present disclosure.

FIGS. 6A-6D illustrate a sequence of snapshots at different time steps for the solution of the MILP problem, according to some embodiments of the present disclosure.

FIG. 7 is a schematic illustrating by non-limiting example a computing apparatus for implementing the methods and the systems of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

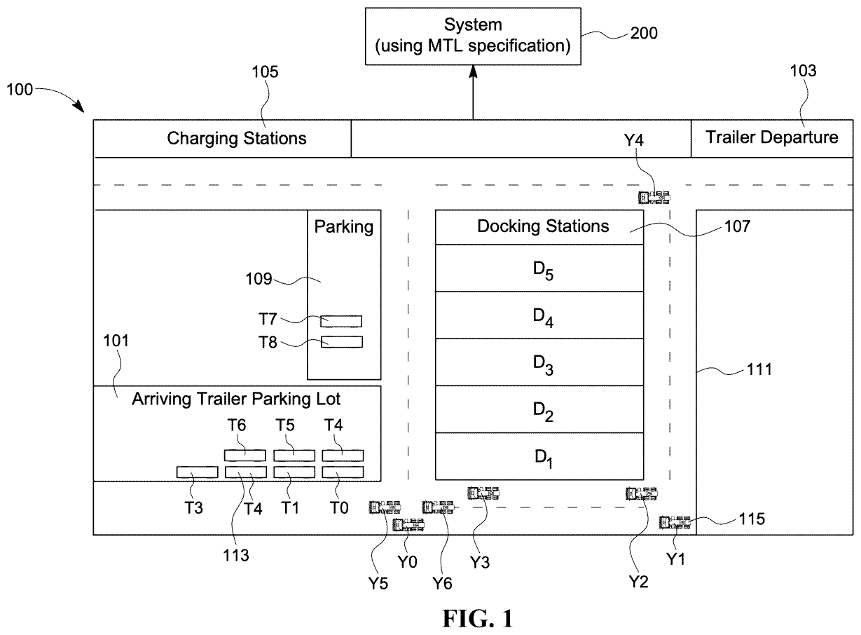

FIG. 1 illustrates a logistics environment 100, according to an embodiment of the present disclosure. The logistics environment 100 is a facility or an area where goods are moved, loaded, unloaded, and temporarily stored, typically involving a high degree of coordination and automation. The logistics environment 100 includes arriving trailer parking lot 101, a trailer departure location 103, a charging station 105, docking stations (D1-D5) 107, a temporary parking area 109, and roads 111. The arriving trailer parking lot 101 is a designated area where trailers 113 that are arriving at the facility transported by long-haul tractors are parked before being processed further. For example, trailers 113 arriving at the facility are parked temporarily before being processed further.

Each of the trailers 113 refers to a non-motorized cargo transport unit that is designed to be towed by a powered vehicle, such as an autonomous or human driven tractor or yard vehicle. The trailer may include, but is not limited to, standard freight containers mounted on chassis, dry van trailers, refrigerated trailers, flatbeds, tankers, or other types of towable units used for transportation and temporary storage of goods. In certain embodiments, the trailers 113 may be equipped with sensors, communication modules, or onboard power sources to support monitoring, positioning, or interaction with other systems. The term “trailer” may also encompass semi-trailers and full trailers, whether loaded or empty, and may be coupled or uncoupled from the towing vehicle depending on operational context. A fleet of vehicles 115 manages the movement of the trailers 113 in the logistics environment 100. The fleet of vehicles 115 includes trailer movers, yard trucks, and/or robots.

The trailer departure location 103 is an area from which trailers leave the logistics environment 100 after they have been loaded or unloaded and are ready for transport. The logistics environment 100 includes the charging station 105 for restoring energy levels of the fleet of vehicles 115. For instance, the charging station 105 includes fuel stations for fueling up the fleet of vehicles 115. In some embodiments, the fleet of vehicles 115 are electric vehicles and the charging station 105 includes battery charging stations for recharging the electric vehicles.

The docking stations (i.e., loading/unloading) 107 are bays where the trailers 113 are backed in to load or unload goods. The temporary parking area 109 is an area where the trailers 113 can be held temporarily during logistics operations-such as while waiting for a dock to open up. Further, the logistics environment 100 includes the roads 111 that allow movement of the fleet of vehicles 115 and the trailers 113 between various locations (e.g., parking lots, docking stations, charging stations).

It is an objective of some embodiments to coordinate and control the movement of the trailers 113 by the fleet of vehicles 115 to perform a set of trailer transportation jobs. The set of trailer transportation jobs include moving the trailers 113 to their target locations in the logistics environment 100 and staying/lodging the trailers at their target locations for a certain duration. The target location includes the trailer departure location 103, the charging station 105, the docking stations 107, or the temporary parking area 109. The present disclosure provides a system 200 for coordinating and controlling the movement of the trailers 113 by the fleet of vehicles 115 to perform the set of trailer transportation jobs in the logistics environment 100.

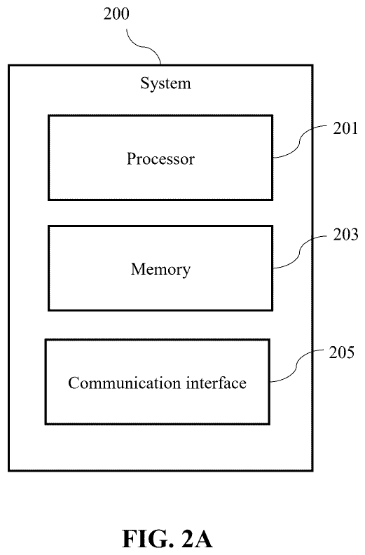

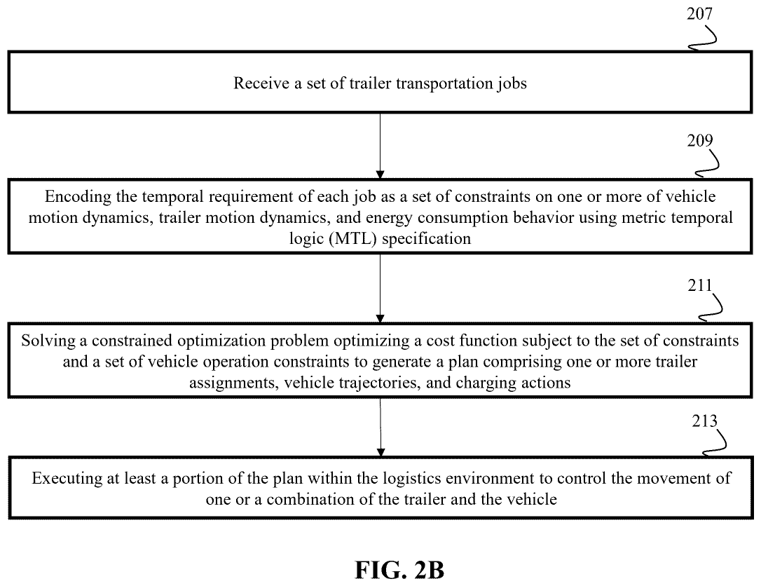

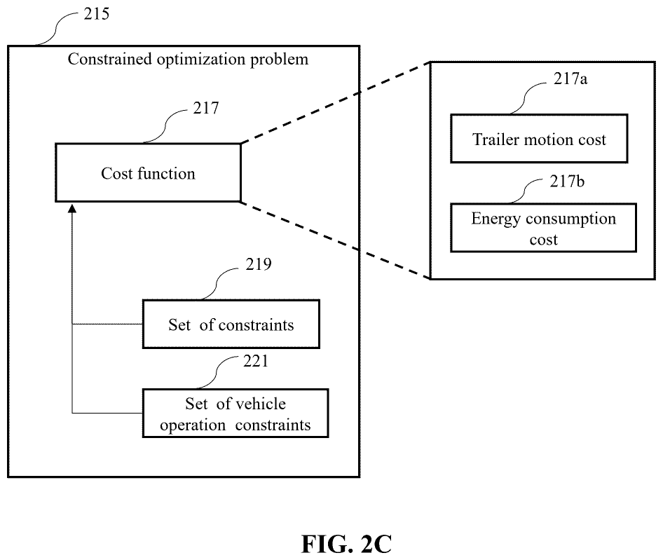

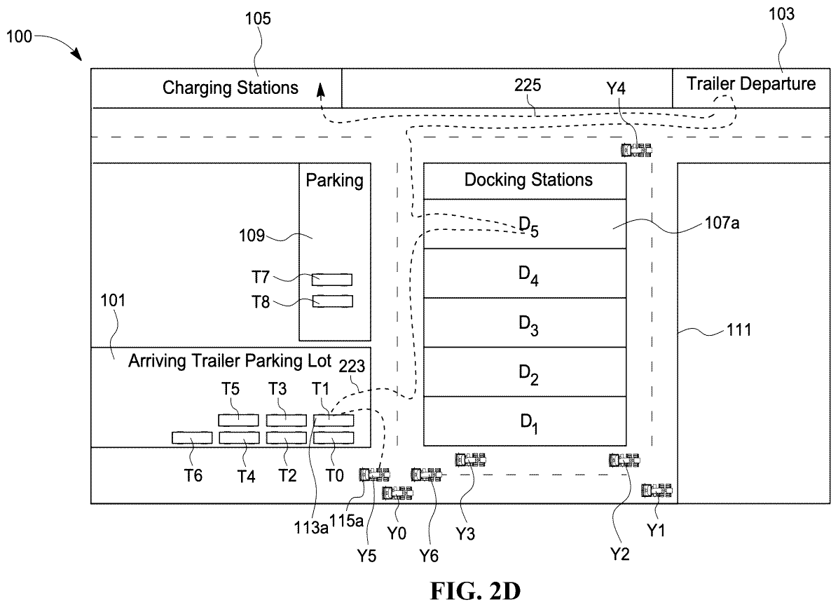

FIG. 2A illustrates a system 200 for coordinating and controlling the movement of the trailers 113 by the fleet of vehicles 115 in the logistics environment 100, according to some embodiments of the present disclosure. The system 200 is communicatively coupled to the fleet of vehicles 115. The system 200 includes a processor 201, a memory 203, and a communication interface 205. The processor 201 may be a single core processor, a multi-core processor, a computing cluster, or any number of other configurations. The memory 203 may include random access memory (RAM), read only memory (ROM), flash memory, or any other suitable memory systems. Additionally, in some embodiments, the memory 203 may be implemented using a hard drive, an optical drive, a thumb drive, an array of drives, or any combinations thereof.

The communication interface 205 may be any means such as a device or circuitry embodied in either hardware or a combination of hardware and software that is configured to receive and/or transmit data from/to other electronic devices in communication with the system 200. In this regard, the communication interface 205 may include, for example, an antenna (or multiple antennas) and supporting hardware and/or software for enabling communications with a plurality of different types of networks, such as first and second types of networks. Additionally or alternatively, the communication interface 205 may include the circuitry for interacting with the antenna(s) to cause transmission of signals via the antenna(s) or to handle receipt of signals received via the antenna(s).

Further, the memory 203 includes instructions stored thereon that, when executed by the processor 201, cause the processor 201 to execute functions to coordinate and control the movement of the trailers 113 by the fleet of vehicles 115.

FIG. 2B illustrates the functions executed by the processor 201 to coordinate and control the movement of the trailers 113 by the fleet of vehicles 115, according to some embodiments of the present disclosure. The vehicles 115 may be referred to as yard dogs (YDs). At block 207, the processor 201 is configured to receive a set of trailer transportation jobs. Each trailer transportation job includes a temporal requirement defining conditions to be satisfied by a trailer or a vehicle at a location during a time interval. For instance, a trailer transportation job includes moving a trailer to its target location in the logistics environment 100 and staying/lodging the trailer at the target location for a certain duration. In some embodiments, each trailer transportation job is decomposed into multiple tasks, such as moving a YD to a trailer, connecting to the trailer, moving the trailer to a sequence of specific regions, such as the docking station 107, the trailer departure location 103, and eventually disconnecting from the trailer.

Some embodiments are based on the recognition that the problem of coordinating the movement of the trailers is not merely one of assigning tasks, but involves multiple interdependent subproblems: job allocation, trajectory generation, and energy management. These subproblems influence each other—for example, a route taken by a YD affects the time and energy required to complete a trailer transportation job, which in turn influences the feasibility of the trailer transportation job itself. This interdependence gives rise to what may be termed an internal coordination problem, wherein treating these subproblems in isolation can result in infeasible, inefficient, or suboptimal operations.

To address the internal coordination problem, some embodiments recognize that the trailer transportation jobs and their constraints can be expressed using a formal specification language, specifically, Metric Temporal Logic (MTL). MTL specification allows for capturing the trailer transportation jobs in terms of task completion, and all timing requirements. Expressing the trailer transportation jobs using the MTL specification enables consolidation of the set of trailer transportation jobs, operational constraints, and timing rules into a unified formal representation that can be systematically compiled into a planning problem.

To this end, at block 209, the processor 201 is configured to encode the temporal requirement of each trailer transportation job as a set of constraints on one or more of vehicle motion dynamics, trailer motion dynamics, and energy consumption behavior using MTL specification. The vehicle motion dynamics refers to the mathematical and physical behavior that describes how a vehicle moves in response to control inputs (like steering, throttle, and braking), environmental conditions (like friction, slope), and constraints (like weight and turning radius). The trailer motion dynamics refers to the behavior of a trailer-especially how it follows or reacts to the towing vehicle's motion. Since the trailers are passive (no steering or propulsion), their dynamics are influenced by the motion of the towing vehicle and their physical configuration. The energy consumption behavior refers to how much energy (fuel or electric) is used during vehicle and trailer operations, and how that consumption varies based on dynamic factors like load, terrain, driving pattern, and acceleration.

Additionally, in some embodiments, the processor 201 is configured to receive a state of each vehicle of the fleet of vehicles 115. The state of the vehicle includes a location and an energy level of the vehicle. The energy level may correspond to a charge level of vehicle's on-board battery or a fuel level of the vehicle. The processor 201 is configured to encode the state of each vehicle as the set of constraints using the MTL specification, in addition to encoding the temporal requirement of each trailer transportation job as the set of constraints.

The set of constraints can be included in a constrained optimization problem, e.g., mixed integer linear programming problem, where a cost function includes performance objectives, e.g., minimizing trailer motions and energy consumption. Further, the constrained optimization problem can be solved to generate a plan for coordinating and controlling the movement of the trailers 113.

At block 211, the processor 201 is configured to solve the constrained optimization problem optimizing a cost function subject to the set of constraints and a set of vehicle operation constraints to generate the plan. Such a constrained optimization problem is explained below in FIG. 2C.

FIG. 2C illustrates a constrained optimization problem 215, according to some embodiments of the present disclosure. The constrained optimization problem 215 includes a cost function 217 including a trailer motion cost 217a and an energy consumption cost 217b. The trailer motion cost 217a minimizes the motion of the trailers 113. In particular, the trailer motion cost 217a minimizes unnecessary trailer motions that don't contribute to completion of the trailer transportation jobs. The energy consumption cost 217b indicates a total amount of energy of the fleet of vehicles 115. Optimizing such a cost function 217 optimizes the overall energy usage and increases the available energy in the fleet of vehicles 115 so that the vehicles 115 are ready for the next trailer transportation job, thereby allowing efficient planning of the motion of the trailers 113 and the fleet of vehicles 115 in the logistics environment 100.

The cost function 217 is subject to a set of constraints 219 and a set of vehicle operation constraints 221. The set of constraints 219 encodes the temporal requirement of each trailer transportation job and/or the state of each vehicle using the MTL specification, as described above. The set of vehicle operation constraints 221 include one or more of: constraints on trailer flow conservation, constraints on vehicle flow conservation, vehicle energy constraints, constraints that avoid undesirable trailer behaviors, and a docking maneuver constraint. The vehicle energy constraints capture the energy level of each vehicle of the fleet of vehicles 115. During a docking maneuver, a vehicle performs specific motions to align the trailer with the docking station. The docking maneuver constraint avoids one or more vehicles of the fleet of vehicles 115 crossing a road and the docking station where the docking maneuver is being performed. Each of these vehicle operation constraints are described in detail in later part of the present disclosure.

The processor 201 is configured to solve the constrained optimization problem 215 optimizing the cost function 217 subject to the set of constraints 219 and the set of vehicle operation constraints 221 to generate the plan. The generated plan includes one or more trailer assignments, vehicle trajectories, and charging actions. The one or more trailer assignments include assignment of one or more vehicles of the fleet of vehicles 115 to respective trailers of the trailers 113. The vehicle trajectories include a trajectory for the one or more vehicles of the fleet of vehicles 115 for performing the set of trailer transportation jobs. The charging actions include a trajectory towards the charging station 105 and a charging schedule for the one or more vehicles of the fleet of vehicles 115. As the plan is generated by solving the constrained optimization problem optimizing the cost function 217 that includes the trailer motion cost 217a and an energy consumption cost 217b, the generated plan satisfies the set of constraints 219 and minimizes the motion of the trailers 113 and the energy consumption of the fleet of vehicles 115, thereby allowing energy-efficient motion planning and logistics operation. Further, as the motion of the trailers 113 is minimized, wear and tear of parts of the trailers 113 is minimized, leading to longer life span of the parts of the trailers 113 and reduction of maintenance of the trailers 113.

Referring back to FIG. 2B, at block 213, the processor 201 is configured to execute at least a portion of the plan within the logistics environment 100 to control the movement of one or more trailers of the trailers 113 by the one or more vehicles of the fleet of vehicles 115. The one or more vehicles of the fleet of vehicles 115 are autonomous vehicles and the processor 201 controls the one or more vehicles according to the plan to complete the set of trailer transportation jobs.

FIG. 2D illustrates an example plan and execution of the plan, according to some embodiments the present disclosure. For the purpose of explanation, the plan and the execution of the plan is explained with respect to a single trailer and vehicle. For example, the generated plan includes an assignment of a vehicle 115a of the fleet of vehicles 115 to a trailer 113a of the trailers 113, a trajectory 223 for the vehicle 115a, and a trajectory 225 towards the charging station 105. The vehicle 115a is an autonomous vehicle. To execute the plan, the processor 201 assigns the vehicle 115a to the trailer 113a. Further, the processor 201 controls one or more actuators of the assigned vehicle 115a according to the trajectory 223. To control the one or more actuators of the assigned vehicle 115a according to the trajectory 223, the processor 201 is configured to generate control commands based on the trajectory 225 and apply the control commands to the one or more actuators, causing the assigned vehicle 115a to track the trajectory 223. Such controlling of the vehicle 115a according to the trajectory 223 navigates the vehicle 115a to the trailer 113a, connects to the trailer 113a, moves the trailer 113a to a sequence of specific regions, such as the docking station D5 107a, the trailer departure location 103, and eventually disconnects from the trailer 113a.

Likewise, the processor 201 further controls the vehicle 115a according to the trajectory 225 to reach the charging station 105 and restore an energy level of the vehicle 115a. In some embodiments, the processor 201 transmits the generated plan to a control system of the vehicle 115a. The control system is configured to control the vehicle 115a according to the generated plan.

In some embodiments, the fleet of vehicles 115 include semi-autonomous or manual vehicles. In such embodiments, the processor 201 transmits the generated plan to the semi-autonomous or manual vehicles. For instance, the processor 201 transmits the generated plan to auditory and/or visual interfaces of the semi-autonomous or manual vehicles. The plan is provided to drivers of the semi-autonomous or manual vehicles through the auditory and/or visual interfaces. For instance, the auditory interfaces may include spoken instructions delivered through speakers or headsets, while the visual interfaces may include in-vehicle displays, mobile applications, or navigation screens. The drivers can then interpret and execute the received plan by manually controlling their respective vehicles according to the plan. This arrangement enables coordinated execution of a common operational plan across both autonomous and human-operated vehicles within the same fleet of vehicles.

Some embodiments recognize that while MTL provides a powerful specification framework, direct enforcement of the set of constraints 219 over long planning horizons through the constrained optimization problem 215 can lead to excessive computational complexity. The size and structure of the constrained optimization problem scale with a number of the vehicles, a number of trailer transportation jobs, and resolution of time discretization, posing a practical barrier to real-time deployment in the logistics environment 100.

To address such a challenge related to the constrained optimization problem 215, some embodiments reformulate the constrained optimization problem 215 into a receding planning horizon framework. In the receding planning horizon framework, the constrained optimization problem is solved iteratively over short, finite horizons, enabling the system 200 to adapt to dynamic task arrivals, vehicle state changes, and execution variability. The receding planning horizon framework maintains tractability while enabling responsiveness to real-time changes.

Another recognition underlying some embodiments is that binary treatment of constraint satisfaction may obscure the utility of partial task progress, which is especially present in a receding horizon operation. In typical logic-based formulations, a constraint is either satisfied in full or not at all. However, in the receding planning horizon framework employed by some embodiments, actions that move a trailer closer to its target location or prepare a YD for a future assignment may still be highly valuable, particularly in constrained or overloaded scenarios. Hence, some embodiments modify the cost function 217 by including a continuous satisfaction term that represents a degree of progress toward satisfaction of the set of trailer transportation tasks.

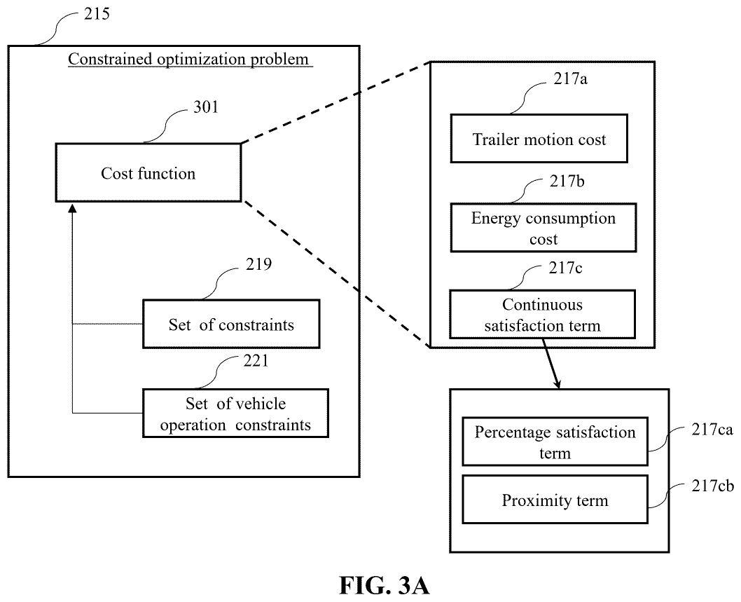

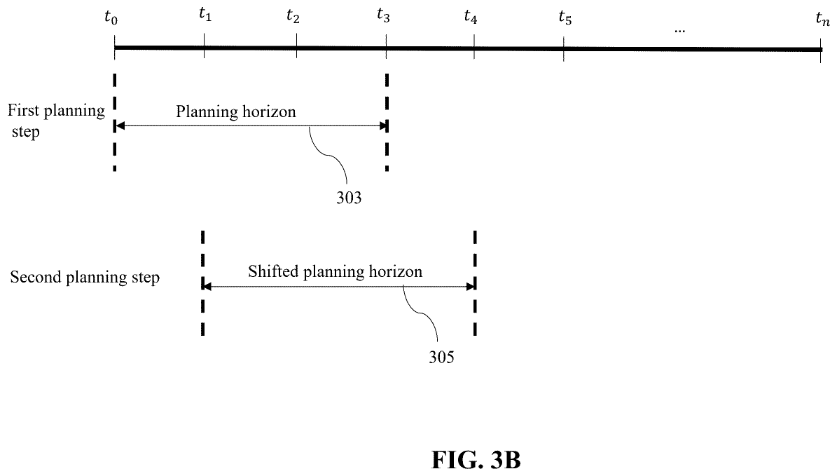

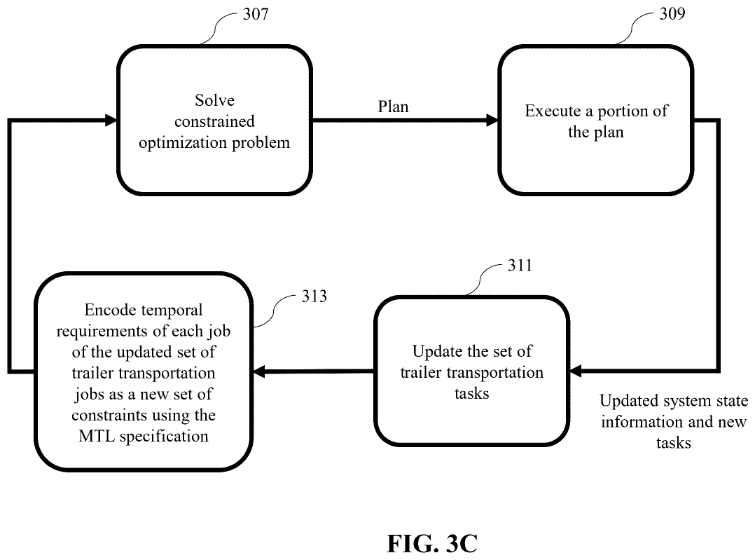

FIG. 3A illustrates the constrained optimization problem 215 with a modified cost function 301, according to some embodiment of the present disclosure. The modified cost function 301 includes the trailer motion cost 217a, the energy consumption cost 217b, and a continuous satisfaction term 217c. The continuous satisfaction term 217c represents a degree of progress toward satisfaction of the set of trailer transportation jobs. In particular, the continuous satisfaction term includes a percentage satisfaction term 217ca that indicates the satisfaction of the set of trailer transportation jobs in terms of a percentage of satisfaction of the set of constraints that encodes the temporal requirement of each trailer transportation job using MTL specification. However, the progress towards satisfaction of the set of constraints alone may not be sufficient with short horizon to move the trailers towards their target locations, because moving a tractor towards a goal for a short time duration by itself may not reduce a degree of satisfaction of the set of constraints. Thus, the continuous satisfaction term 217c also includes a proximity term 217cb indicative of a measure of proximity of the trailer to a target location associated with a temporal requirement of a trailer transportation job of the set of the trailer transportation jobs. The target location includes the trailer departure location 103, the charging station 105, the docking stations 107, or the temporary parking area 109. The measure of proximity of the trailer to the target location is computed based on a shortest path distance between a current location of the trailer and the target location.

The processor 201 is configured to solve the constrained optimization problem 215 optimizing the cost function 301 subject to the set of constraints 219 and the set of vehicle operation constraints 221 to generate the plan. The processor 201 solves the constrained optimization problem 215 over a receding planning horizon that is shorter than at least one temporal requirement of the set of trailer transportation tasks. Solving the constrained optimization problem 215 over the receding planning horizon is explained below in FIGS. 3B and 3C.

FIG. 3B illustrates the receding planning horizon framework, according to some embodiments of the present disclosure. FIG. 3C illustrates solving the constrained optimization problem 215 over the receding planning horizon, according to some embodiments of the present disclosure. FIG. 3B and FIG. 3C are explained in conjunction with each other. In a first planning step, the processor 201 solves 307 the constrained optimization problem 215 over a planning horizon (t₀ to t₃) 303 to determine a plan that includes one or more of the trailer assignments, the vehicle trajectories, and the charging actions. Further, the processor 201 executes 309 a portion of the control plan. As a result of the execution of the portion of the plan, a position and an energy level of the one or more vehicles of the fleet of vehicles 115 are updated, one or more trailer transportation jobs of the set of trailer transportation jobs are partially executed and another one or more trailer transportation jobs of the set of trailer transportation jobs are fully executed.

In the next planning cycle (i.e., second planning cycle), the planning horizon 303 shifts forward (recedes) and the processor 201 receives updated system state information at t₁. The updated state system information includes the updated position and the updated energy level of the one or more vehicles of the fleet of vehicles 115. Additionally, in some embodiments, the processor 201 receives new trailer transportation jobs and updates 311 the set of trailer transportation tasks by adding the new trailer transportation jobs, removing the fully executed trailer transportation tasks, and retaining the partially executed trailer transportation tasks. The processor 201 encodes 313 temporal requirements of each job of the updated set of trailer transportation jobs as a new set of constraints using the MTL specification. The temporal requirements of each job define conditions to be satisfied by a trailer or a vehicle at a location during a time interval. Further, the processor 201 formulates a constrained optimization problem that optimizes the cost function 301 subject to the new set of constraints and the set of vehicle operation constraints 221.

Further, the processor 201 solves the formulated constrained optimization problem over a shifted prediction horizon (t₁ to t₄) 305 to determine a new plan and the process repeats until all the trailer transportation tasks are fully executed. The shifted prediction horizon 305 is also referred to as a successive planning horizon. In such a manner, the solving and executing steps are repeated over successive receding planning horizons based on the updated system state information. Such a receding planning horizon framework enables continuous feedback and provides some degree of robustness and prevents errors from accumulating, which is especially important for long horizon operations.

Therefore, the system 200 supports a planning and controlling framework that is not only formally grounded and computationally efficient, but also operationally effective in real-world environments. Further, the system 200 adapts to changing conditions, maximizes throughput, and utilizes resources efficiently.

In some embodiments, the cost function 301 of the constrained optimization problem 215 comprises a weighted combination of two or more of: the trailer motion cost 217a, the energy usage cost 217b, and the continuous satisfaction term 217c.

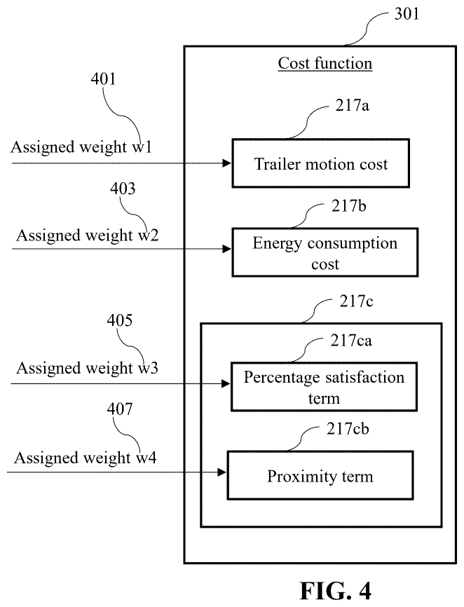

FIG. 4 illustrates the cost function 301 including weighted costs, according to some embodiments of the present disclosure. The trailer motion cost 217a is assigned with a weight w1 401, the energy usage cost 217b is assigned with a weight w2 403, the percentage satisfaction term 217ca assigned with a weight w3 405 and the proximity term 217cb is assigned with a weight w4 407. The values of the weights 401, 403, 405 and 407 are defined by a user to prioritize the performance objectives as desired. For example, the weights 405 and 407 are assigned higher values than the values of the weights 401 and 403 to prioritize job completion during high-demand intervals. Therefore, the weights 401, 403, 405 and 407 allow to flexibly prioritize different aspects of performance according to real-time operational contexts. Additionally, such weight assignment enhances adaptability, robustness, and responsiveness of the system 200 in automated warehouse logistics planning.

In some embodiments, the constrained optimization problem 215 is a Mixed Integer Linear Programming (MILP) problem. The MILP problem is a type of mathematical optimization problem where an objective is to maximize or minimize a linear function, subject to a set of linear constraints.

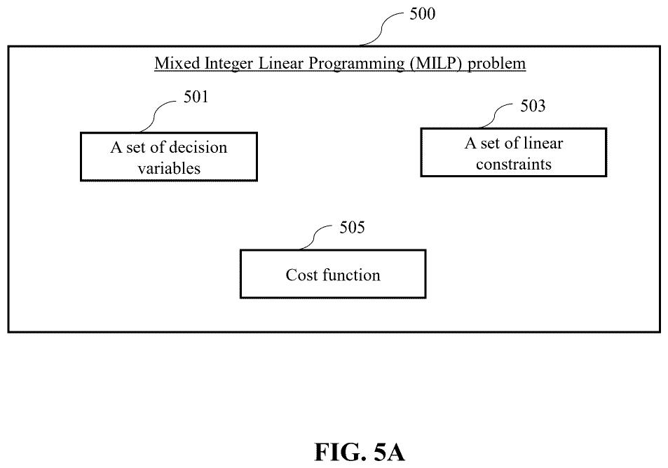

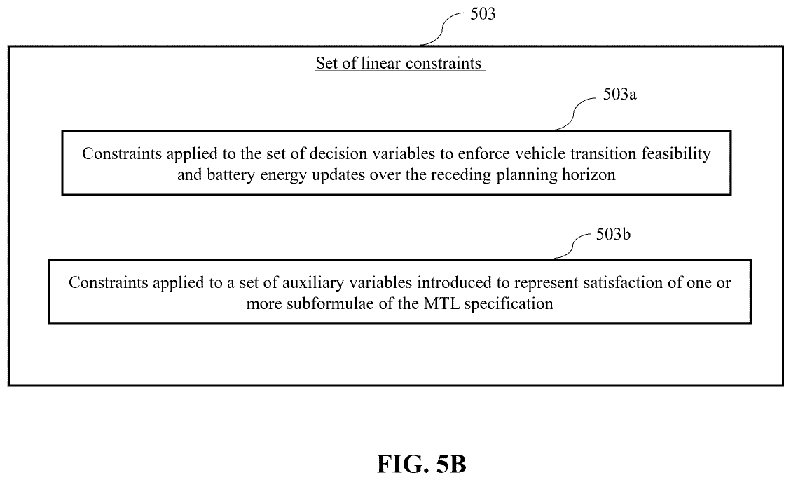

FIG. 5A illustrates the MILP problem 500, according to some embodiments of the present disclosure. The MILP problem 500 includes a set of decision variables 501, a set of linear constraints 503, and a cost function 505. The set of decision variables 501 represents the trailer assignments, the vehicle trajectories, and the charging actions over a receding planning horizon. The set of linear constraints 503 are derived from the MTL specification, the vehicle motion dynamics, the trailer motion dynamics, and the energy consumption behavior. The cost function 505 includes one or more terms selected from: the trailer motion cost 217a, the energy consumption cost 217b, and the continuous satisfaction term 217c.

FIG. 5B illustrates the set of linear constraints 503, according to some embodiments of the present disclosure. The set of linear constraints 503 includes constraints 503a applied to the set of decision variables 501 to enforce vehicle transition feasibility and battery energy updates over the receding planning horizon. The set of linear constraints 503 further includes constraints 503b applied to a set of auxiliary variables introduced to represent satisfaction of one or more subformulae of the MTL specification.

The formulation of the MILP problem 500 is mathematically described below.

Let [symbol] denote a set of all real numbers, [symbol] a set of integers, [symbol] a binary set, and [symbol] _{≥0} a set of non-negative integers. For a set [symbol] , [symbol] and | [symbol] | represent its power set and cardinality, and α+S={α+x|x∈S}. An integer interval (range) from a to b is [a . . . b], and I=a, Ī=b. j-th component of x∈ [symbol] ^{d} is given by xⱼ, j∈[1 . . . d].

MTL is a formal specification language that expresses explicit real-time system properties. The temporal requirement of each trailer transportation task is using the MTL specification comprising one or a combination of temporal operators including a bounded eventually operator, a bounded always operator, and a bounded until operator. Syntax of MTL is

$$ϕ ∷ = ⊤ \vert ¬ ϕ \vert π \vert {ϕ}_{1} ∧ {ϕ}_{2} \vert {ϕ}_{1} ∨ {ϕ}_{2} \vert {□}_{I} ϕ \vert {◇}_{I} ϕ ,$$

where φ, φ₁, φ₂ are MTL formulae, T denotes a logical value True, and π∈Π is an atomic proposition. operators ¬, ∨, ∧ are Boolean negation, disjunction, and conjunction, respectively. Additionally, □_{I} and ⋄_{I} represent the bounded eventually operator and the bounded always operator, with I=[a . . . b], 0≤a≤b, denoting a discrete-time interval. The logical value False is expressed as ⊥=¬T. Semantics of the MTL formula φ at time k is defined recursively over discrete-time signals s:[0 . . . ∞]→2^{Π}, where s=s(0), s(1), . . . represents a sequence of sets of atomic propositions, i.e., s(k)∈2^{Π},

$$( s , k ) ⊨ π ≡ π ∈ s ( k ) , \qquad ( 1 )$$

$$( s , k ) ⊨ ¬ ϕ ≡ ( s , k ) \text{?} ϕ ,$$

$$( s , k ) ⊨ {ϕ}_{1} ∧ {ϕ}_{2} ≡ ( s , k ) ⊨ {ϕ}_{1} ∧ ( s , k ) ⊨ {ϕ}_{2} ,$$

$$( s , k ) ⊨ {ϕ}_{1} ∨ {ϕ}_{2} ≡ ( s , k ) ⊨ {ϕ}_{1} ∨ ( s , k ) ⊨ {ϕ}_{2} ,$$

$$( s , k ) ⊨ {◇}_{I} ϕ ≡ ∃ {k}^{′} ∈ k + I , ( s , {k}^{′} ) ⊨ ϕ ,$$

$$( s , k ) ⊨ {□}_{I} ϕ ≡ ∀ {k}^{′} ∈ k + I , ( s , {k}^{′} ) ⊨ ϕ .$$

Symbols [symbol] , [symbol] , ≡ represent satisfaction, violation, and equivalence, respectively. A discrete-time signal s satisfies the MTL formula, denoted by s [symbol] φ, if and only if (s, 0) [symbol] φ

A time horizon of the MTL formula is defined as

$$‖ ϕ ‖ = \{ \begin{matrix}0 , & if ϕ = π , \\ ‖ {ϕ}_{1} ‖ , & if ϕ = ¬ {ϕ}_{1} , \\ max \{ ‖ {ϕ}_{1} ‖ , ‖ {ϕ}_{2} ‖ \} , & if ϕ ∈ \{ {ϕ}_{1} ∧ {ϕ}_{2} , {ϕ}_{1} ∨ {ϕ}_{2} \} , \\ ‖ ϕ ‖ + \overline{I} , & if ϕ ∈ \{ {□}_{I} ϕ , {◇}_{I} ϕ \} .\end{matrix} \qquad ( 2 )$$

The YDs pick up, transport, position, and release trailers at various locations, such as arrival, loading, unloading, holding, and departure areas. Requests specifying where trailers must be placed are defined using MTL. The YD batteries deplete while operating; hence, YD operations must also account for recharging and maintaining sufficient battery levels for the entire fleet of YDs.

Logistics environment—The logistics environment 100 is abstracted as a weighted transition system, represented by a tuple [symbol] =( [symbol] , ε, [symbol] , Π, [symbol] ), where [symbol] denotes a finite set of locations of interest (states), and ε⊆ [symbol] × [symbol] captures the possible transitions between locations. A function [symbol] :ε→ [symbol] _{≥1} assigns a travel duration to each transition, while Π is a set of atomic propositions that label the states in [symbol] . A state-labeling function [symbol] : [symbol] →2^{Π} associates each state with a subset of atomic propositions. A stationary YD at q∈ [symbol] is modeled by a unit-weight self-transition, i.e., (q, q)∈ε for all q∈ [symbol] , with [symbol] ((q, q))=1.

YD−A YD y∈ [symbol] is defined by its position s_{y}(k)∈ [symbol] ∪ε and battery state by (k)∈ [symbol] at time k∈[0 . . . . H], where H is a time horizon and [symbol] is a set of all YDs. A trajectory s_{y}: [symbol] _{≥0}→ [symbol] ∪ε captures the motion of YD y, i.e., occupied locations q∈ [symbol] and traversed transitions e∈ε, in the environment [symbol] at each time k∈[0 . . . . H].

A synchronous trajectory of the YD fleet is denoted by s [symbol] : [symbol] _{≥0}→(Q∪ε) [symbol] . The energy consumption cost for the fleet of YDs [symbol] is

$${𝒥}_{b} = {\sum }_{y ∈ 𝓎} {\sum }_{k = 0}^{H} {b}_{y} ( k ) .$$

Trailer-A trailer t∈ [symbol] is defined by its position sₜ(k)∈( [symbol] \ [symbol] _{c})∪ε at time k∈[0 . . . . H], where H is the time horizon, [symbol] is a set of all trailers, and [symbol] _{c}:={q|q∈ [symbol] ⁻¹ (π_{charching})} is a set of charging stations. A trajectory sₜ: [symbol] _{≥0}→( [symbol] \ [symbol] _{c})∪ε captures the motion of trailer t, i.e., occupied locations q∈ [symbol] and traversed transitions e∈ε, in the environment [symbol] at each time k∈[0 . . . . H].

The trailers cannot enter charging stations and cannot be in states labeled as “road” without a YD assigned to it, i.e., cannot be left in the middle of the road. A synchronous trajectory of all trailers is denoted by [symbol] : [symbol] _{≥0}→(Q∪ε) [symbol] .

Let

$${s}_{t}^{𝒬} = {q}_{0} {q}_{1} …$$

be a sequence of states in Q visited by the trajectory sₜ of trailer t∈ [symbol] , and

$$ℰ ( {s}_{t}^{𝒬} ) = ( ( {q}_{ℓ} , {q}_{ℓ + 1} ) \vert ℓ ∈ [ 0 … \vert {s}_{t}^{𝒬} \vert - 1 ] , {q}_{ℓ} \neq {q}_{ℓ + 1} )$$

be a sequence of transitions in ε that excludes self-transitions (q, q) that capture stationary trailers. A motion cost of all trailers is

$${𝒥}_{m} = {\sum }_{t ∈ 𝒯} {\sum }_{e ∈ ℰ ( {s}_{t}^{𝒬} )} 𝒲 ( e ) .$$

MTL primitive units to describe mission specifications (i.e., trailer transportation tasks) are requests that capture the target location to which a specific trailer must be moved, and the minimum time to be spent at that location.

Request—A request is a tuple r=(t, d, πᵣ), where t∈ [symbol] is the trailer tasked to move to a region with label πᵣ∈Πᵣ⊆Π, where Πᵣ correspond to the docking stations, arrival, and departure locations, and stay there for a duration d∈ [symbol] _{≥1}. A set of all requests in the mission is defined as [symbol] ={r₁, . . . , r_{|R|}}.

The docking stations, arrival, and departure locations qᵣ have exactly one label from Πᵣ, i.e., | [symbol] (qᵣ)|=1.

The request can be translated into MTL specifications via φᵣ=□_{[0,d]}ω̅_{t,q}, where ω̅_{t,q} denotes that trailer t is at location q∈ [symbol] labeled with [symbol] (q)={πᵣ} and therefore serve request r∈ [symbol] .

A transportation schedule Asg: [symbol] ×[0 . . . . H]=→ [symbol] ∪{ϵ} is an assignment of YDs y to trailers t at each time k, where ϵ denotes no YD is assigned. A feasible transportation is feasible if (i) motion is synchronized, s_{y}(k)=sₜ(k) whenever y=Asg(t,k), and (ii) every YD pulls at most one trailer, |{t|Asg(t,k)=y}|≤1 for all y∈ [symbol] , k∈[0 . . . . H].

Plan—A plan Γ is a joint state trajectory [symbol] , [symbol] generated by the YDs pulling trailers to and from docking, arrival, and departure locations in the environment [symbol] , and transportation schedule Asg. Formally, ( [symbol] , [symbol] ) [symbol] φ such that by (k)≥0 for all y∈ [symbol] and k∈[0 . . . . H], and Asg is feasible.

It is an objective of some embodiments to solve the following problem: Given a fleet of YDs [symbol] , an abstracted environment [symbol] , a group of trailers [symbol] , and an MTL specification φ over requests [symbol] , find a plan Γ such that φ is satisfied and cost [symbol] = [symbol] _{b}− [symbol] ₘ is maximized. Such a problem is formulated as the MILP problem.

The motion of YDs and the trailers is modeled as a flow network problem. Then, the flow of trailers is constrained by the flow of YDs, so a trailer can only move together with a YD, i.e., by being carried by it. Let binary variables Y_{q,i,k}∈ [symbol] and U_{e,i,k}∈ [symbol] represent whether the YD i∈ [symbol] is at state q∈ [symbol] or traversing edge e∈ε at time k≤∥φ∥, with ∥φ∥ time horizon of the specification computed as in (3). Similarly, T_{q,j,k}∈ [symbol] and V_{e,j,k}∈ [symbol] are binary variables that represent whether trailer j∈ [symbol] is at state q∈ [symbol] or traversing edge e∈ε at time k≤∥φ∥.

The constraints on YD/vehicle flow conservation are

$${Y}_{q , i , 0} = \vert \{ i ∈ 𝒴 \vert {q}_{0 , i} = q \} \vert , \qquad ( 3 )$$

$${Y}_{q , i , k} = {\sum }_{( {q}^{′} , q ) ∈ ℰ} {U}_{( {q}^{′} , q ) , i , k - 𝒲 ( {q}^{′} , q )} \leq {N}_{q}^{y} ,$$

$${\sum }_{( q , {q}^{′} ) ∈ ℰ} {U}_{( q , {q}^{′} ) , i , k} = {\sum }_{( {q}^{′} , q ) ∈ ℰ} {U}_{( {q}^{′} , q ) , i , k - 𝒲 ( {q}^{′} , q )} ,$$

for all q∈2, i∈ [symbol] , k∈[0 . . . ∥φ∥], where Y_{q,i,0} is an initial distribution of YDs in the environment, and Y_{q,i,k} are the YDs in state q∈ [symbol] at time k≤∥φ∥ considering durations of incoming edge transitions. Additionally,

$${N}_{q}^{y}$$

imposes a capacity constraint that may be used to guarantee no collisions of YDs at road nodes

$$( {N}_{q}^{y} = 1 ,$$

for all q∈ [symbol] with label π=π_{road}) or the maximum number of YDs to enter same charging station node

$$( {N}_{q}^{y} ∈ {ℤ}_{\geq 1} ,$$

for all q∈ [symbol] with label π=π_{charging}). Finally, Σ_{(q,q′)∈ε}U_{(q,q′),i,k} imposes conservation of YD flow by requiring that a number of YDs in incoming (q′, q)∈ε and outgoing (q, q′)∈ε edges is equal.

The constraints on trailer flow conservation are

$${T}_{q , j , 0} = \vert \{ j ∈ T \vert {q}_{0 , j} = q \} \vert , \qquad ( 4 )$$

$${T}_{q , j , k} = {\sum }_{( {q}^{′} , q ) ∈ ℰ} {V}_{( {q}^{′} , q ) , j , k - 𝒲 ( {q}^{′} , q )} ,$$

$${\sum }_{( q , {q}^{′} ) ∈ ℰ} {V}_{( q , {q}^{′} ) , j , k} = {\sum }_{( {q}^{′} , q ) ∈ ℰ} {V}_{( {q}^{′} , q ) , j , k - 𝒲 ( {q}^{′} , q )} .$$

for all q∈ [symbol] , j∈ [symbol] , and k∈[0 . . . ∥φ∥], where T_{q,j,0} is an initial distribution of trailers, T_{q,j,k} is a number of trailers in state q∈ [symbol] at time k≤∥φ∥ considering the durations of the incoming edge transitions, and Σ_{(q,q′)∈ε} V_{(q,q′),j,k} imposes conservation of the trailer flow by requiring that a number of trailers in incoming (q′, q)∈ε and outgoing (q, q′)∈ε edges is equal.

The trailers must be moved by the YDs, hence their motion is coupled over every edge e=(q, q′)∈ε\{q=q′}, except in self-loops since the trailer is stationary, resulting in the constraints

$${V}_{e , j , k} \leq {\sum }_{i ∈ 𝒴} {U}_{e , i , k} , {\sum }_{j ∈ 𝒯} {V}_{e , j , k} + {\sum }_{i ∈ 𝒴} {U}_{e , i , k} \leq 2 , \qquad ( 5 )$$

for all k∈[0 . . . ∥φ∥], where it is enforced that the motion of YDs and trailers are coupled, i.e., no trailer can transition to another state if a YD is not transitioning on the same edge, and that only a YD is assigned to a trailer.

The constraints that avoid undesirable trailer behaviors: To prevent the trailers from being “temporarily abandoned” at road nodes, the following constraint is imposed

$${\sum }_{i ∈ 𝒴} {Y}_{{q}^{r} , i , k} \geq {\sum }_{j ∈ 𝒯} {T}_{{q}^{r} , j , k} . \qquad ( 6 )$$

for all q^{r}:={q|q∈ [symbol] ⁻¹(π_{road})} and at all times k∈[0 . . . ∥φ∥].

Similarly, to avoid that two YDs “switch trailers” during their operations, the following constraint is imposed

$${\sum }_{i ∈ 𝒴} {U}_{e = ( q , {q}^{′} ) , i , k} + {\sum }_{i ∈ 𝒴} {U}_{e = ( {q}^{′} , q ) , i , k} \leq 1 , \qquad ( 7 )$$

for all k∈[0 . . . ∥φ∥] and e=(q, q′)∈ε\{q=q′} where q and q′ belong to road or docking labeled nodes.

Further, some embodiments prevent YDs from bringing the trailers to the charging stations by imposing

$${T}_{q , j , k} = 0 , ∀ q ∈ {ℒ}^{- 1} ( π = {π}_{c harging} ) . \qquad ( 8 )$$

The combination of (4)-(9) ensures that a YD picks up a trailer only if it has enough energy to move the trailer to a destination (i.e., target location).

The docking maneuver constraint: A docking maneuver occurs when a YD transporting a trailer is positioned at a loading station dock. During this maneuver, the YD must perform specific motions to align the trailer with the loading station dock. The docking maneuver constraint prohibits other YDs from crossing the road while the docking maneuver is ongoing,

$${U}_{{e}^{+} , i , k} + {U}_{\tilde{e} , i , \tilde{k}} \leq 1 , \qquad ( 9 )$$

where e⁺ is a set of incoming edges of all road states q^{r}∈ [symbol] neighbors of the respective loading station except for self-loops and docking node, \tilde{e} is an edge linking the road and the docking station where the maneuver is performed, and \tilde{k} is a duration of the maneuver.

The vehicle energy constraints: The energy spent by each YD is proportional to a traveled distance. The YDs can recharge at designated charging stations. This allows them to restore their energy levels and resume contributing to completing the mission. Let E_{i,k} capture the remaining amount of energy a YD i∈ [symbol] has at time k∈[0 . . . ∥φ∥], the vehicle energy constraints capturing the YD energy are

$${E}_{i , k + w ( e )} > = {E}_{i , k} - {D}_{e} + {C}_{e} - ( 1 - {U}_{e , i , k} ) \cdot M , \qquad ( 10 )$$

$${E}_{i , k + w ( e )} < = {E}_{i , k} - {D}_{e} + {C}_{e} + ( 1 - {U}_{e , i , k} ) \cdot M ,$$

where Cₑ∈ [symbol] _{≥0} is a charging rate at charging stations and Dₑ∈ [symbol] _{≥0} is a discharging rate at a specific transition e∈ε, and M is a sufficiently large number, i.e., greater than battery capacity.

For encoding request satisfaction, a binary variable

$${z}_{k}^{r}$$

∈ [symbol] which is 1 if request r∈ [symbol] is satisfied at time k∈[0 . . . ∥φ∥] and 0 if violated, is used. Thus,

$${z}_{k}^{r} \leq {T}_{q , j , k} , \qquad ( 11 )$$

for all r=(t, d, πᵣ) with πᵣ∈Πᵣ⊆Π, t∈ [symbol] , d∈ [symbol] _{≥0} ensures that trailer j∈ [symbol] is at location q∈ [symbol] at a requested time k∈[0 . . . ∥φ∥]. Some embodiments enforce the entire MTL specification by using encoding that comprises generating a Boolean variable corresponding to each MTL subformula at each discrete time step within a planning horizon. In particular, the entire MTL specification is enforced by a recursive encoding that assigns a binary variable

$${z}_{k}^{ϕ}$$

∈ [symbol] to each subformula φ at time k, such that

$${z}_{k}^{ϕ} = 1$$

if and only if φ holds at time k.

The cost function 217 includes multiple terms modeling different performance objectives. A trailer should move only if necessary to satisfy the mission specification. Thus, the trailer motion cost 217a is considered

$${τ}_{T} = {\sum }_{k = 0}^{\vert \vert ϕ \vert \vert} {\sum }_{j ∈ 𝒯} {\sum }_{( q , {q}^{′} ) ∈ ε ∖ ( q , q ) )} {V}_{e , j , k} , \qquad ( 12 )$$

where τ_{T} captures all of the trailer motion during the mission. The trailer motion cost is normalized by weight σ_{τ}=λ_{τ}/(∥φ∥·| [symbol] |), where λ_{T}∈[0,1] is a priority weight to define priorities in the cost function.

For YDs, it is desirable to minimize energy usage and incentivize recharging at the charging station when the energy is low. Therefore, the energy consumption cost 217b is considered function term

$${τ}_{B} = {\sum }_{k = 0}^{\vert \vert ϕ \vert \vert} {\sum }_{i ∈ y} {E}_{i , k} , \qquad ( 13 )$$

where τ_{B} is a total amount of energy of the fleet of YDs available, which optimizes the overall energy usage and increases the available energy in the YDs so that they are ready for the next task. The energy consumption cost 217b is normalized by the weight σ_{B}=λ_{B}/(∥φ∥·| [symbol] |), where λ_{T}∈[0,1] is another priority weight. Combining these terms, the cost function 217 is given as as [symbol] =σ_{B}·τ_{B}−σ_{T}·τ_{T}.

The MILP problem is formulated as

$${max}_{Y , u , T , v , B , Z} 𝒥 s . t . {T}_{q , j , k} ⊨ ϕ , ( 3 ) - ( 10 ) \qquad ( 14 )$$

For the problem (14), the MTL specification must be satisfiable for initial YD and trailer conditions and given requests within the planning horizon along which (14) is formulated. Determining a planning horizon that ensures satisfiability of the MTL specifications without being excessively large to avoid negative impact on the computation time is challenging, especially for scenarios with several trailers, YDs, and requests. Thus, some embodiments modify the MILP problem in (14) to be solved in the receding planning horizon.

The MILP problem in (14) is reformulated to operate in the receding planning horizon, which makes it easier to design mission specifications that are feasible since the planning horizon can be extended without negatively impacting the computational load. Some embodiments consider that the mission specification has the fixed structure

$$\tilde{ϕ} = {∧}_{r ∈ ℛ} {◇}_{[ l b , ub ]} r ( t , d , {π}_{r} ) , \qquad ( 15 )$$

for all r∈ [symbol] , with lb and ub being predefined lower and upper bound of the time interval for the eventually operator. Instead of considering only satisfaction or violation of the mission specification, embodiments of the present disclosure use an encoding that accounts for fractions of satisfaction, allowing the mission to be partially satisfiable. This is enabled by a recursive encoding that uses a variable

$${z}_{k}^{\tilde{ϕ}} ∈ [ 0 , 1 ]$$

for Boolean and temporal operators capturing a percentage of satisfaction and

$${z}_{k}^{{π}_{r}}$$

∈ [symbol] for atomic propositions. This can be simply obtained by using as a slack variable in the constraints that represent the MTL specification. Let g_{\tilde{φ}}(W)≤0 be the constraint encoding (15), where W includes all the variables in g_{\tilde{φ}} in a single vector. Let M be a (possibly vector) upper bound to g_{\tilde{φ}} for all values of W that are allowed. Then,

$${g}_{\tilde{ϕ}} ( W ) \leq M ( 1 - {z}_{k}^{\tilde{ϕ}} )$$

results in

$${z}_{k}^{\tilde{ϕ}}$$

representing the percentage of satisfaction of the formula, i.e., for

$${z}_{k}^{\tilde{ϕ}} = 0$$

a full relaxation is required for the constraint to be satisfied and thus 0% satisfaction, for

$${z}_{k}^{\tilde{ϕ}} = 1$$

no relaxation is required and hence 100% satisfaction. Then, to obtain a trajectory that fully satisfies the formula, (14) is solved iteratively over a shifting time horizon until the specification is fully satisfied, which indicates that all requests have been served. However, to encourage solution of (14) to progress in partially satisfying a specification, which moves the solution towards the full satisfaction of the specification and avoids deadlocks, the cost function 217 is modified as explained below.

Each request specifies that a particular trailer must move from its current location to a designated destination. Thus, a set of minimal distance paths from the trailers starting positions to their targets is computed using Dijkstra's algorithm. Let [symbol] ᵣ represent a set of shortest paths for trailer t in request r=(t, d, πᵣ)∈ [symbol] , from its current location q∈ [symbol] to the target location labeled by proposition q_{d}= [symbol] ⁻¹(πᵣ). For each request, a monotonically decreasing cost function Θ(r) along the paths in [symbol] ᵣ is computed. Θ(r) is designed to encourage the trailer to advance towards its destination progressively,

$$Θ ( q , r ) = \{ \begin{matrix}c \cdot d ( q , {q}_{d} ) , & {q}_{d} = {ℒ}^{- 1} ( {π}_{r} ) ∧ q ∈ {𝒫}_{r} \\ C , & otherwise\end{matrix} , \qquad ( 16 )$$

where c and C∈ [symbol] _{≥0}, such that c≤C are constant bounds for the cost function, and d(q, q_{d}) is Dijkstra computed distance. Therefore, the continuous satisfaction term 217c representing the progress towards the destination is

$${τ}_{p} = {\sum }_{k = 0}^{\vert \vert ϕ \vert \vert} {\sum }_{j ∈ 𝒯} {\sum }_{q ∈ Q} Θ ( q , r ) \cdot {T}_{q , j , k} , \qquad ( 17 )$$

for all r∈ [symbol] . τₚ becomes smaller if the state gets closer to the destination. The continuous satisfaction term 217c is normalized by weight σₚ=λₚ/(∥\tilde{φ}∥·| [symbol] |), where λₚ∈[0,1] is a priority weight.

For a receding horizon solution that progresses towards the satisfaction of the MTL specification by partial satisfaction and progress towards satisfaction, the cost function [symbol] is modified into

$$𝒥 R = {z}_{0}^{\tilde{ϕ}} + {τ}_{B} \cdot {σ}_{B} - {τ}_{T} \cdot {σ}_{T} - {τ}_{p} \cdot {σ}_{p} ,$$

and as a consequence the MILP problem (14) is modified into

$${max}_{Y , u , T , v , B , Z} {𝒥}_{R} s . t . {T}_{q , j , k} ⊨ \tilde{ϕ} , ( 3 ) - ( 10 ) \qquad ( 3 )$$

In the receding planning horizon framework, (18) is solved over a fixed horizon, a part of the solution is stored, and then it is solved again along a shifted horizon. Such an iterative solution may simply be a way to control computational load, i.e., without any feedback, which amounts to initializing the next problem from the previous problem solution. However, the receding horizon solution may also implement feedback by commanding the YDs with an initial part of the solution computed at a current step and then solving again at a future step over the shifted horizon using updated positions of the YDs and the trailers at that time.

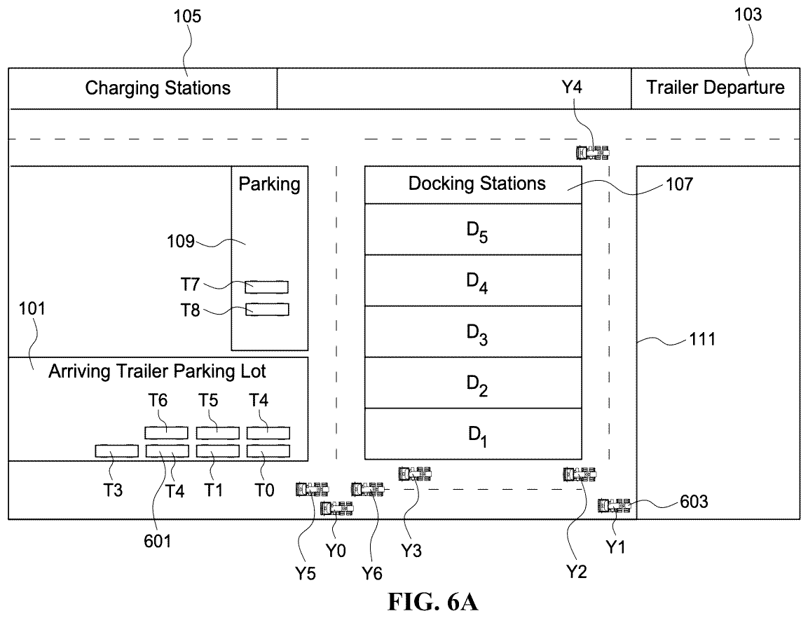

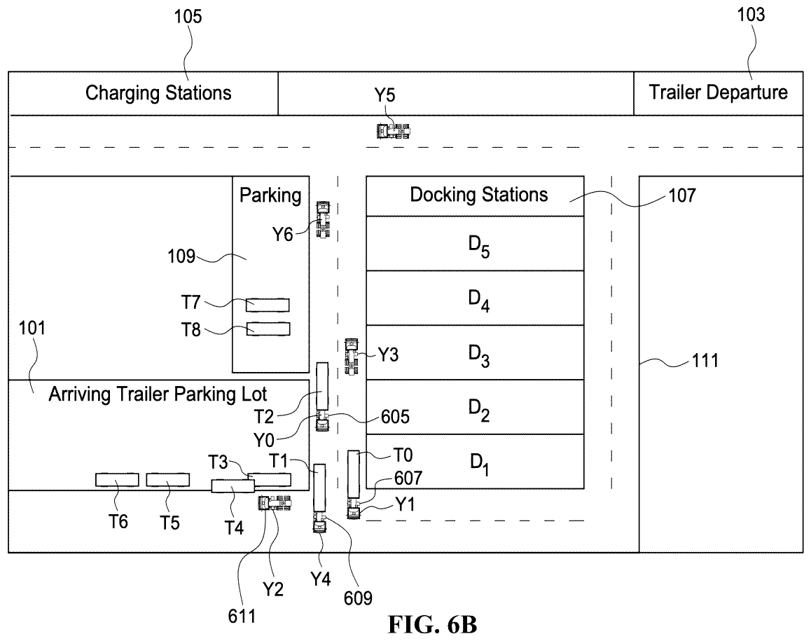

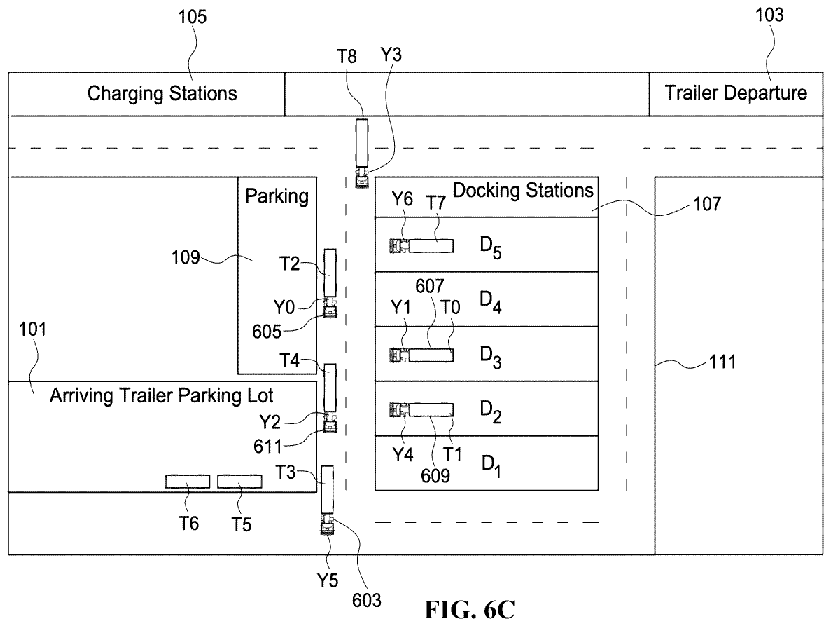

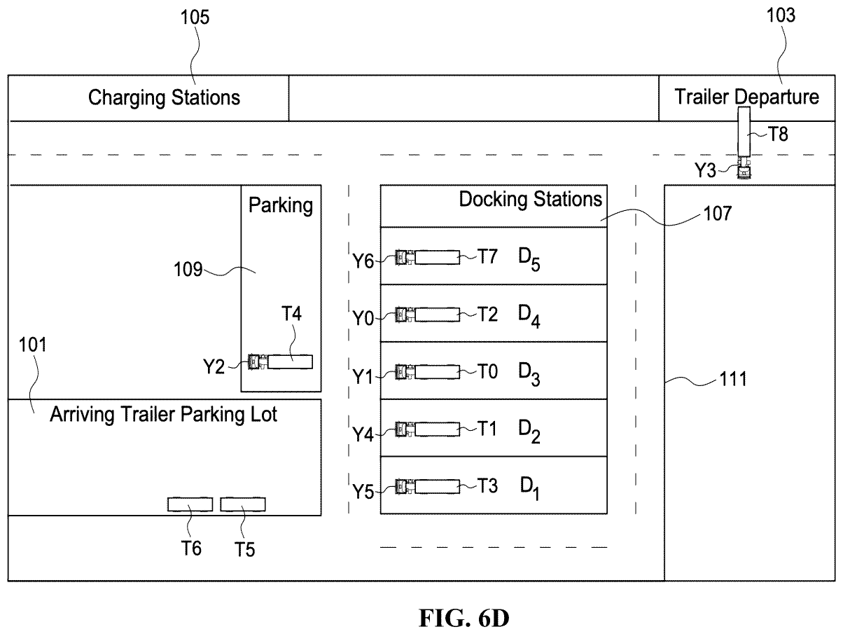

FIGS. 6A-6D illustrate a sequence of snapshots at different time steps for the solution of the MILP problem (14), according to some embodiments of the present disclosure. FIG. 6A illustrates a snapshot at time step k=0, according to some embodiments of the present disclosure. At k=0, trailers (T0-T8) 601 and YDs (Y0-Y5) 603 have an initial position. Further, battery energy levels range from 0 to 100 energy units, and initially, all the YDs are at full charge capacity.

FIG. 6B illustrates a snapshot at time step k=6, according to some embodiments of the present disclosure. At k=6, the YDs have already moved and three trailers T0, T1, and T2 are being transported by allocated YDs 605, 607, and 609, respectively. Further, YD 611 is picking up trailer T4 at the arriving trailer parking lot 101.

FIG. 6C illustrates a snapshot at time step k=6, according to some embodiments of the present disclosure. At k=12, trailers T0, T1, and T7 have reached their destinations, and other trailers are being transported by YDs.

FIG. 6D illustrates a snapshot at time step k=18, according to some embodiments of the present disclosure At k=18, trailers T0-T4, T7, and T8 have reached their destinations and fully satisfied the mission. Trajectories followed by the YDs to complete the mission are collision-free since

$${N}_{q}^{y} = 1$$

for road and dock nodes.

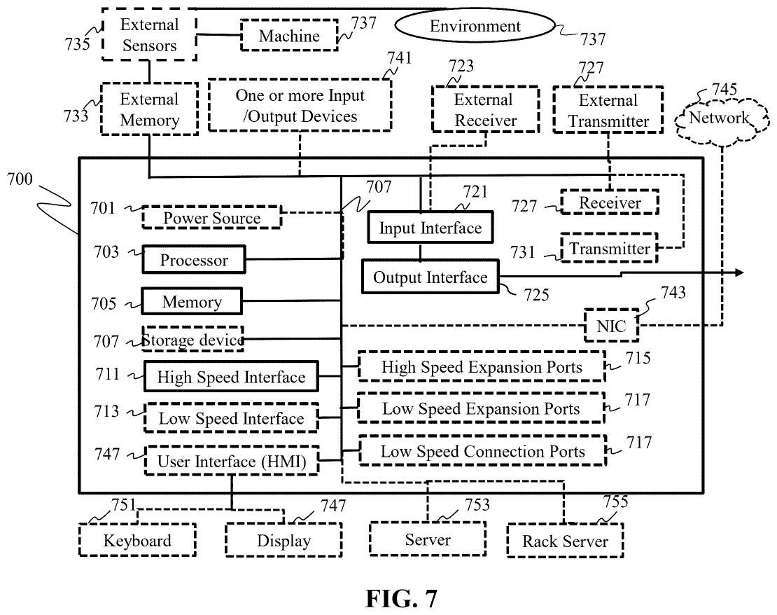

FIG. 7 is a schematic illustrating by non-limiting example a computing apparatus for implementing the methods and the systems of the present disclosure. The computing device 700 can include a power source 701, a processor 703, a memory 705, a storage device 707, all connected to a bus 709. Further, a high-speed interface 711, a low-speed interface 713, high-speed expansion ports 715 and low speed connection ports 717, can be connected to the bus 709. In addition, a low-speed expansion port 719 is in connection with the bus 709. Further, an input interface 721 can be connected via the bus 709 to an external receiver 723 and an output interface 725. A receiver 727 can be connected to an external transmitter 729 and a transmitter 731 via the bus 709. Also connected to the bus 709 can be an external memory 733, external sensors 735, machine(s) 737, and an environment 739. Further, one or more external input/output devices 741 can be connected to the bus 709. A network interface controller (NIC) 743 can be adapted to connect through the bus 709 to a network 745, wherein data or other data, among other things, can be rendered on a third-party display device, third party imaging device, and/or third-party printing device outside of the computer device 700.

The memory 705 can store instructions that are executable by the computer device 700, historical data, and any data that can be utilized by the methods and systems of the present disclosure. The memory 705 can include random access memory (RAM), read only memory (ROM), flash memory, or any other suitable memory systems. The memory 705 can be a volatile memory unit or units, and/or a non-volatile memory unit or units. The memory 705 may also be another form of computer-readable medium, such as a magnetic or optical disk.

The storage device 707 can be adapted to store supplementary data and/or software modules used by the computer device 700. For example, the storage device 707 can store historical data and other related data as mentioned above regarding the present disclosure. Additionally, or alternatively, the storage device 707 can store historical data like data as mentioned above regarding the present disclosure. The storage device 707 can include a hard drive, an optical drive, a thumb-drive, an array of drives, or any combinations thereof. Further, the storage device 707 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, the processor 703), perform one or more methods, such as those described above.

The computing device 700 can be linked through the bus 709, optionally, to a display interface or user Interface (HMI) 747 adapted to connect the computing device 700 to a display device 749 and a keyboard 751, wherein the display device 749 can include a computer monitor, camera, television, projector, or mobile device, among others. In some implementations, the computer device 700 may include a printer interface to connect to a printing device, wherein the printing device can include a liquid inkjet printer, solid ink printer, large-scale commercial printer, thermal printer, UV printer, or dye-sublimation printer, among others.

The high-speed interface 711 manages bandwidth-intensive operations for the computing device 700, while the low-speed interface 713 manages lower bandwidth-intensive operations. Such allocation of functions is an example only. In some implementations, the high-speed interface 711 can be coupled to the memory 705, the user interface (HMI) 747, and to the keyboard 751 and the display 749 (e.g., through a graphics processor or accelerator), and to the high-speed expansion ports 715, which may accept various expansion cards via the bus 709. In an implementation, the low-speed interface 713 is coupled to the storage device 707 and the low-speed expansion ports 717, via the bus 709. The low-speed expansion ports 717, which may include various communication ports (e.g., USB, Bluetooth, Ethernet, wireless Ethernet) may be coupled to the one or more input/output devices 741. The computing device 700 may be connected to a server 753 and a rack server 755. The computing device 700 may be implemented in several different forms. For example, the computing device 700 may be implemented as part of the rack server 755.

The description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Further, embodiments of the present disclosure and the functional operations described in this specification can be implemented in digital electronic circuitry, in tangibly-embodied computer software or firmware, in computer hardware, including the structures disclosed in this specification and their structural equivalents, or in combinations of one or more of them. Further some embodiments of the present disclosure can be implemented as one or more computer programs, i.e., one or more modules of computer program instructions encoded on a tangible non transitory program carrier for execution by, or to control the operation of, data processing apparatus. Further still, program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

According to embodiments of the present disclosure the term “data processing apparatus” can encompass all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

A computer program can be deployed to be executed on one computer or on multiple computers that are located at one site or distributed across multiple sites and interconnected by a communication network. Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

We claim:

1. A system for coordinating and controlling the movement of trailers by a fleet of vehicles within a logistics environment, comprising: a processor; and a memory having instructions stored thereon that, when executed by the processor, cause the controller to:
receive a set of trailer transportation jobs, each trailer transportation job comprising a temporal requirement defining conditions to be satisfied by a trailer or a vehicle at a location during a time interval;
encode the temporal requirement of each trailer transportation job as a set of constraints on one or more of vehicle motion dynamics, trailer motion dynamics, and energy consumption behavior using a metric temporal logic (MTL) specification;
solve a constrained optimization problem optimizing a cost function subject to the set of constraints and a set of vehicle operation constraints to generate a plan comprising one or more trailer assignments, vehicle trajectories, and charging actions, wherein the cost function includes a trailer motion cost and an energy consumption cost indicative of a total amount of energy of the fleet of trucks; and
execute at least a portion of the plan within the logistics environment to control the movement of the trailers by the fleet of vehicles.

2. The system of claim 1, wherein the processor is configured to solve the constrained optimization problem over a receding planning horizon that is shorter than at least one of the temporal requirement of the set of trailer transportation jobs, and wherein the cost function includes a continuous satisfaction term that represents a degree of progress toward satisfaction of the set of trailer transportation tasks.

3. The system of claim 2, wherein the continuous satisfaction term is defined by a percentage satisfaction term indicative of a percentage of satisfaction of the set of constraints and a proximity term indicative of a measure of proximity of the trailer to a target location associated with a temporal requirement of a trailer transportation job of the set of the trailer transportation jobs.

4. The system of claim 3, wherein the measure of proximity is computed based on a shortest path distance between a current location of the trailer and the target location.

5. The system of claim 1, wherein the processor is further configured to receive, post execution of the portion of the plan, updated system state information including an updated position and an updated energy level of at least one vehicle of the fleet of vehicles.

6. The system of claim 5, wherein the processor is further configured to solve the constrained optimization problem over a successive planning horizon based on the updated system state information.

7. The system of claim 6, wherein the processor is further configured to update the set of trailer transportation jobs for the successive planning horizon by adding one or more newly received jobs, removing one or more fully executed trailer transportation jobs of the set of trailer transportation jobs, and retaining one or more partially executed tasks trailer transportation jobs of the set of trailer transportation jobs.

8. The system of claim 1, wherein the cost function comprises a weighted combination of two or more of: the trailer motion cost, the energy usage cost, and a continuous satisfaction term that represents a degree of progress toward satisfaction of the set of trailer transportation tasks.

9. The system of claim 1, wherein the constrained optimization problem is a Mixed Integer Linear Programming (MILP) problem, the MILP problem comprises:
a set of decision variables representing the trailer assignments, the vehicle trajectories, and the charging actions over a receding planning horizon;
a set of linear constraints derived from the MTL specification, the vehicle motion dynamics, the trailer motion dynamics, and the energy consumption behavior; and
the cost function comprising one or more terms selected from: the trailer motion cost, the energy consumption cost, and a continuous satisfaction term that represents a degree of progress toward satisfaction of the set of trailer transportation tasks.

10. The system of claim 9, wherein the set of linear constraints comprises:
constraints applied to the set of decision variables to enforce vehicle transition feasibility and battery energy updates over the receding planning horizon; and
constraints applied to a set of auxiliary variables introduced to represent satisfaction of one or more subformulae of the MTL specification.

11. The system of claim 1, wherein the temporal requirement of each trailer transportation job is expressed using the MTL specification comprising one or a combination of a bounded eventually operator and a bounded always operator.

12. The system of claim 1, wherein, to encode the temporal requirement of each trailer transportation job, the processor is further configured to generate a Boolean variable corresponding to each MTL subformula at each discrete time step within a planning horizon.

13. The system of claim 1, wherein the set of vehicle operation constraints includes one or more of: constraints on trailer flow conservation, constraints on vehicle flow conservation, vehicle energy constraints, constraints that avoid undesirable trailer behaviors, and a docking maneuver constraint.

14. The system of claim 13, wherein the vehicle energy constraints capture an energy level of each vehicle of the fleet of vehicles, and wherein the docking maneuver constraint avoids one or more vehicles of the fleet of vehicles crossing a road and a docking station where a docking maneuver is being performed.

15. The system of claim 1, wherein the fleet of vehicles includes one or more autonomous vehicles, and wherein to execute at least the portion of the plan, the processor is further configured to:
generate, based on the plan, one or more control commands to the one or more autonomous vehicles; and
control the one or more autonomous vehicles according to the one or more control commands.

16. The system of claim 1, wherein the fleet of vehicles includes one or more manual vehicles, wherein, to execute at least the portion of the plan, the processor is further configured to transmit the plan to auditory or visual interfaces of the one or more manual vehicles, wherein the plan is provided to drivers of the one or more manual vehicles through the auditory or visual interfaces, and wherein the one or more manual vehicles are controlled by their respective drivers according to the plan.

17. A method for coordinating and controlling the movement of trailers by a fleet of vehicles within a logistics environment, the method comprising:
receiving a set of trailer transportation jobs, each job comprising a temporal requirement defining conditions to be satisfied by a trailer or a vehicle at a location during a time interval;
encoding the temporal requirement of each job as a set of constraints on one or more of vehicle motion dynamics, trailer motion dynamics, and energy consumption behavior using metric temporal logic (MTL) specification;
solving a constrained optimization problem optimizing a cost function subject to the set of constraints and a set of vehicle operation constraints to generate a plan comprising one or more trailer assignments, vehicle trajectories, and charging actions, wherein the cost function includes a trailer motion cost and an energy consumption cost indicative of a total amount of energy of the fleet of trucks; and
executing at least a portion of the plan within the logistics environment to control the movement of the trailers by the fleet of vehicles.

18. The method of claim 17, wherein the method further comprises solving the constrained optimization problem over a receding planning horizon that is shorter than at least one of the temporal requirement of the set of trailer transportation jobs, and wherein the cost function includes a continuous satisfaction term that represents a degree of progress toward satisfaction of the set of trailer transportation tasks.

19. The method of claim 18, wherein the cost function comprises a weighted combination of two or more of: the trailer motion cost, the energy usage cost, and a continuous satisfaction term that represents a degree of progress toward satisfaction of the set of trailer transportation tasks.

20. A non-transitory computer-readable storage medium embodied thereon a program executable by a processor for performing a method for coordinating and controlling the movement of trailers by a fleet of vehicles within a logistics environment, the method comprising:
receiving a set of trailer transportation jobs, each job comprising a temporal requirement defining conditions to be satisfied by a trailer or a vehicle at a location during a time interval;
encoding the temporal requirement of each job as a set of constraints on one or more of vehicle motion dynamics, trailer motion dynamics, and energy consumption behavior using metric temporal logic (MTL) specification;
solving a constrained optimization problem optimizing a cost function subject to the set of constraints and a set of vehicle operation constraints to generate a plan comprising one or more trailer assignments, vehicle trajectories, and charging actions, wherein the cost function includes a trailer motion cost and an energy consumption cost indicative of a total amount of energy of the fleet of trucks; and
executing at least a portion of the plan within the logistics environment to control the movement of the trailers by the fleet of vehicles.
